(19) United States
(12) Patent Application Publication
(10) Pub. No.: US 2018/0061269 A1
(43) Pub. Date: Mar. 1, 2018

(54) CONTROL AND SAFETY SYSTEM MAINTENANCE TRAINING SIMULATOR

(71) Applicant: Honeywell International Inc., Morris Plains, NJ (US)

(72) Inventors: MANAS DUTTA, BANGALORE (IN); RAMESH BABU KONIKI, BANGALORE (IN); DEEPAK S. BHANDIWAD, BANGALORE (IN); AMOL KINAGE, BANGALORE (IN); PRAVEEN SHETTY, BANGALORE (IN); MANJUNATHA B. CHANNEGOWDA, BANGALORE (IN)

(21) Appl. No.: 15/254,873

(22) Filed: Sep. 1, 2016

(51) Int. Cl. G09B 19/00; G09B 5/02; G09B 5/12; G06T 19/00; G02B 27/01

(52) U.S. Cl. CPC G09B 19/0069; G09B 5/02; G09B 5/12; G02B 2027/0141; G02B 27/017; G02B 2027/014; G06T 19/006

(57) ABSTRACT

A method of maintenance training simulation includes providing an at least partially virtual reality trainee console having training software, a simulated control and safety system of a plant represented as a data model of simulated hardware devices including a process controller, and a mapping block for interfacing the trainee console to the data model. The mapping block converts an injected hardware fault involving a simulated hardware device to make a change to the data model which changes a current operating state of the simulated system. A response of the process controller is displayed showing changes to the current operating state to the trainee. The mapping block converts an action of the trainee to the changes to the current operating state to generate a further change in the data model. A response of the process controller is displayed showing the further changes in the current operating state to the trainee.

### FIELD

Disclosed embodiments relate to maintenance training simulators for control and safety systems of processing facilities.

### BACKGROUND

Manufacturers employ various approaches to interface their industrial processing facility's (or plant's) Distributed Control System (DCS), Programmable Logic Controller (PLC), or relay system (hereafter a ‘process control system’) with a Safety Instrumented System (hereafter a ‘SIS’). The primary function of a process control system is to hold specific process variables to predetermined levels in a dynamic environment, while a SIS is a system that functions to take action when a process is out of control and as a result the process control system is unable to operate within safe limits. In a plant, the process control system (e.g., DCS) and SIS are typically separate systems that are interfaced to one another through a gateway, with each system generally having its own operator interfaces, engineering workstations, configuration tools, data and event historians, asset management, controller(s), input/output (I/O) module(s), and network communications. The combination of a process control system with a SIS is referred to herein as a ‘control and safety system’.

In modern plant engineering, the IO modules of the process control system and SIS generally receive physical parametric (e.g., pressure, temperature) representations from sensors as standard current signals (4 mA to 20 mA). These signals are utilized by various comparators which compare the incoming 4-20 mA signals received from sensors against stored/set “set points” and create outputs therefrom used for plant safety, regulation, interlock or/and operation.

Plant customers generally employ and maintain a separate physical process control system and SIS training system setup for use exclusively for training their users. For example, for training maintenance engineers to gain hands on experience for the process control system and for the SIS system, for troubleshooting, and for recovery steps from alarm conditions. It is costly and difficult to maintain these physical training systems over a period of time due to respective system obsolescence issues, hardware failures in the respective training systems, and not all types of hardware being procured. Also, actual failures in the control and safety system components are each generally random in nature and do not occur frequently, limiting the exposure and competency that can be achieved by this known physical training system arrangement.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments solve the above-described training problem for control and safety systems by avoiding the need for any actual (physical) process control system hardware or SIS hardware. Instead disclosed embodiments provide a maintenance training simulation (MTS) system including one or more augmented reality (AR) or virtual reality (VR) environment training consoles to implement disclosed methods to perform the training activities for the control and safety system. As used herein a disclosed AR or VR environment training console is referred to herein by the general term “at least partially virtual reality” to cover both AR (virtual (digital) imagery together with a real world scene) and VR (all virtual imagery) training consoles.

The MTS system also includes a data model representation of the simulated control and safety system (simulated system) that are interfaced with a disclosed training console by a mapping block. The mapping block implements mapping software for mapping a set of trainee' (or trainer') actions which can comprise gestures into the data model. The data model includes simulated components for each of the hardware devices including at least one process controller, input/output (IO) device, power supply, network switches, firewall, field devices and processing equipment.

The at least partially virtual reality training console has disclosed training failure scenario and visualization software and is communicably coupled (e.g., an IP network, or a cable) to the simulated system. A trainer console for a trainer is optional. Disclosed training consoles act as a human machine interface (HMI) layer to the simulated system to provide an AR or VR-based view of any portion of the simulated system.

A hardware fault involving at least one of the simulated hardware devices is injected to make changes (e.g., a memory failure of a controller, or a cut wire) to the data model and thus to the current operating state of the simulated system. The injecting can be performed from the trainer console, or from a simulated (software-based) trainer. The controller's response to the simulated system changes is displayed in a first at least partially virtual reality-based view to at least the trainee (optionally to the trainer), and can include an alarm. A response comprising an action of the trainee to the changes is mapped by the mapping block to generate a further change in the data model and thus to the operating state of the simulated system. The controller response to the simulated system reflecting the further change (e.g., alarm removed) is displayed in a second at least partially virtual reality-based view to at least the trainee. Disclosed embodiments apply to both the control system and the SIS system configured as separate systems (e.g. connected through gateways) as well as control and safety systems configured as integrated process control system and SIS systems.

Disclosed MTS systems provide the following:
a) An interface to communicate with a simulated control and safety system.
b) The ability to inject failure scenarios into the simulated system optionally by a trainer using a trainer console. Injection can be entered from (trainer gestures such as the pulling of a network cable, or power off a device. Some injections such as a controller memory failure will generally be through a menu of failure scenarios displayed on a trainer console for the trainer.
c) The trainee recognizing the injected failure conditions from the operating state of the simulated system and responding with an action that changes the operating state of the simulated system as though the actual (physical) version of the injected simulated failures actually occurred.
d) Mapping of system information and the responses from the trainee to the injected failure conditions.

### BRIEF DESCRIPTION OF THE DRAWINGS

FIG. 1 is flow chart showing steps in a method of simulated control and safety system maintenance training, according to an example embodiment.

FIG. 2 is a system diagram for an example MTS system, according to an example embodiment.

FIG. 3 shows a detailed data flow for an example method of simulated control and safety system maintenance training.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Known AR viewing for simulated control and safety systems include operating parameters, but do not consider fault injection into the control and safety system hardware because hardware failures always have some impact on the surrounding subsystem's (i.e., impact on a major system component, such as a controller's) performance and on the industrial process being controlled). Therefore disclosed at least partially virtual reality views of such a hardware centric scenario is recognized to be needed to understand not only actual control and safety system failure, but the system failure's impact on the surrounding subsystems as well as on the process run by the plant. As known in the art in AR instead of replacing reality adds cues (virtual (digital) imagery) onto the already existing real world scene, so that computer graphics are embedded into a real world scene. Disclosed least partially virtual reality-based views can span from all virtual reality to AR. For example, an actual (real-world) cabinet can be displayed in front of trainee(s) and a trainer who can then demonstrate on the AR image how a controller and I/O's can be mounted inside the real cabinet.

Disclosed embodiments solve the control and safety system maintenance training problem by eliminating the need for having a physical control and safety system hardware setup for maintenance training purposes. For disclosed embodiments, the control and safety system (hardware and software) is replaced by the data model of a simulation system that represents the control and safety system hardware components for the purpose of training regarding maintenance needs and for injecting hardware failure scenarios. A method to interface a control and safety system with an at least partially virtual reality training console is provided by a mapping block for mapping a set of trainee (or trainer) actions which can comprise gestures into the data model of the simulated system. Gestures are for a HMI interaction (e.g., hand gesture to change component can also be to switch off power or pulling cables, while actions are broader and include, for example, carrying out a standard maintenance procedure for a given situation in virtual environment to a set of commands which the simulated system can understand and simulate failure conditions, and by mapping the trainee's responses into the data model to a set of visual actions in the at least partially virtual reality consoles.

To provide a trainee a disclosed at least partially virtual reality view, a disclosed trainee console is programmed to enable interfacing with the data model of the simulated system. The training console (trainee console, and optionally also a trainer console) is communicably coupled to a simulated system configures the simulation system and presents it in the at least partially virtual reality view. One example view includes a controller and I/O(s) inside a cabinet with the controller LED in red color, indicating a failure scenario.

The MTS system also converts various actions by the trainee (or trainer) into a meaningful input to the data model of the simulated system. Then the simulation reflects the trainee's change in the current state of the simulated system and results of the change are provided back to the at least partially virtual reality trainee console to visually depict the results of the change. In the at least partially virtual reality view visual objects e.g. the controller, I/O have various attributes such as physical location (e.g. specific cabinet in control room located in a particular floor of a building, images etc.) The simulated control system however recognizes the objects such as a controller with a simple string of characters called a TAG. Mapping software is used for converting the actions to a particular object in an at least partially virtual reality view to an object inside a simulated system.

Often the control and safety system will have an offline configuration capability which later is downloaded to actual hardware once the control and safety system is commissioned. This means in the absence of actual hardware, the disclosed simulation and at least partially virtual reality-based presentation layer needs to understand existing configuration and then display the HMI view accordingly. As noted above, the control and safety system has its own protocol to interact with controllers, and I/O. It usually has a unique command set to act on various devices such as controller and I/O's. Based on a user's (trainee and optional trainer having a console) actions in the at least partially virtual reality console effect on these devices (e.g., controller and I/O's) will be communicated to the simulated system and vice versa. Fault injection and rectification scenarios in the training console is translated by a disclosed mapping block into unique command set which is recognized by the simulated system and it can apply, for example to cause a redundancy failure of a particular controller, set of actions in the at least partially virtual reality console needs to be converted into a command set which is understood by the simulated system. Then simulated system applies these changes to effect the operating state displayed in the training console as alarms/events.

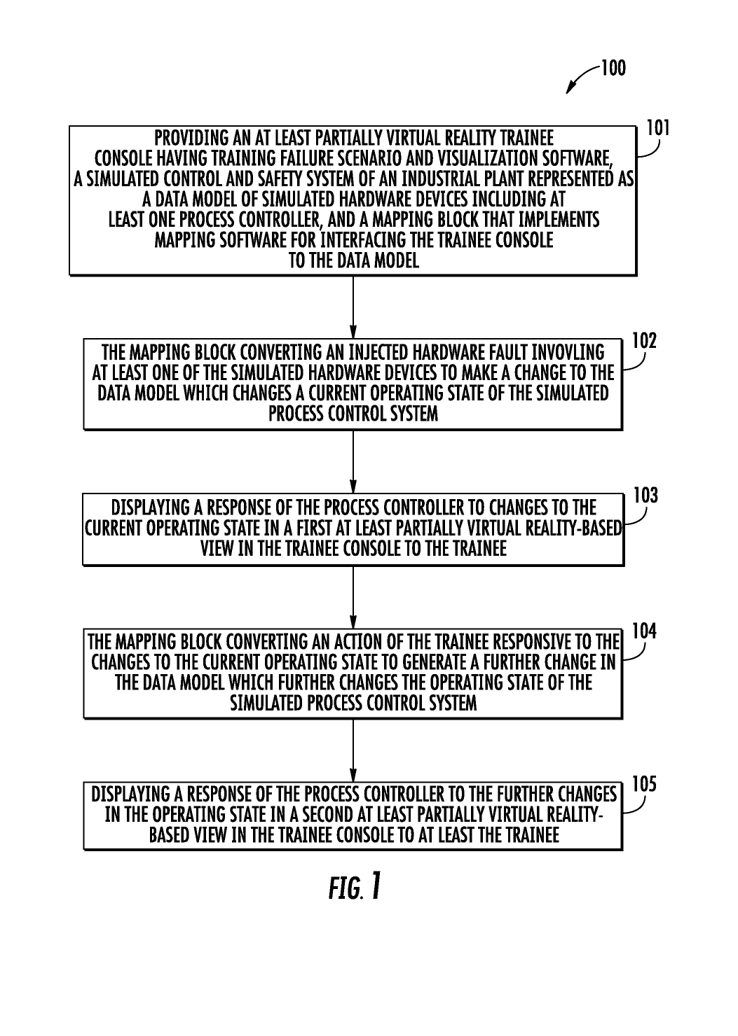

FIG. 1 is flow chart showing steps in a method 100 of maintenance training simulation, according to an example embodiment. Step 101 comprises providing an at least partially virtual reality trainee console having training failure scenario and visualization software, a simulated control and safety system of an industrial plant (simulated system) represented as a data model of simulated hardware devices including at least one process controller, and a mapping block 245 that implements mapping software 245 for interfacing the VR/AR trainee console to the data model representation. The simulated control and safety system can be hosted in a private or in a public cloud or other hosting (e.g. virtualization) infrastructure.

Step 102 comprises the mapping block converting an injected hardware fault involving at least one of the simulated hardware devices to make a change to the data model which changes a current operating state of the simulated system. Step 103 comprises displaying a response of the process controller to changes to the current operating state in a first at least partially virtual reality-based view in the trainee console to the trainee. Step 104 comprises the mapping block converting an action of the trainee responsive to the changes to the current operating state to generate a further change in the data model which further changes the operating state of the simulated system. Step 105 comprises displaying a response of the process controller to the further changes in the operating state in a second at least partially virtual reality-based view in the trainee console to at least the trainee.

The data model can comprise an Open Platform Communications unified architecture (OPC UA) model which is an industrial M2M communication protocol for interoperability developed by the OPC Foundation. The trainee console can comprise a mobile computing device. The simulated hardware devices comprise input/output modules and field instruments. Fault in a simulated hardware device can be generated by modifying a commercially available process simulator including exposing internally maintained hardware fault flags. For example, the Honeywell SimC300 is a commercially available process simulator that can be enhanced for disclosed maintenance training needs. The simulator is enhanced to enable the setting of internally maintained hardware fault flags, such as a RAM failure bit. Generally these are read only flags in such commercially available simulators that are set only if an actual fault occurs. However for disclosed maintenance training purpose these flags are exposed as writable flags which the training system sets based on a users' actions.

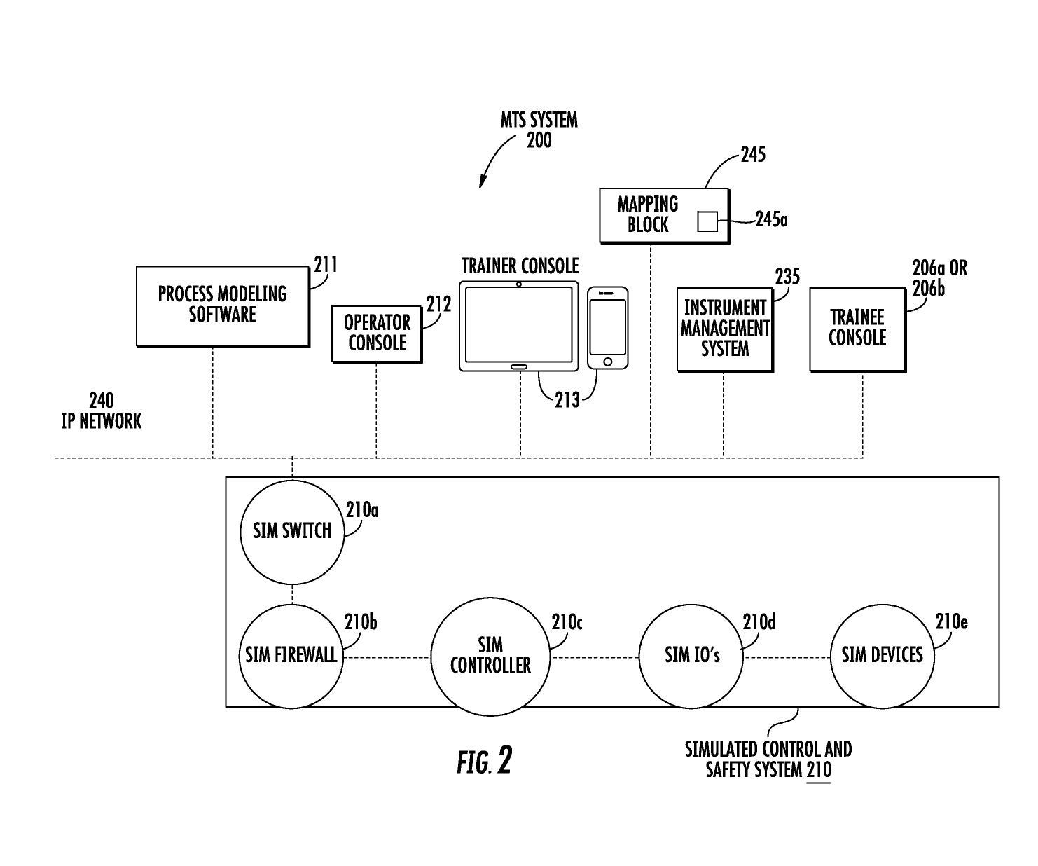

FIG. 2 is system diagram for an example MTS system 200 communicably coupled (networked together) by a network showed as an IP network 235. A trainee has a trainee console 206a or 206b. A trainer console 213 for an optional (human) trainer is also shown. The simulated control and safety system 210 is acted on by the process modeling software 211 that generates a data model representation therefrom. The simulated control and safety system 210 is shown including a SIM switch 210a, a SIM firewall 210b, a Sim process controller 210c, SIM IO 210d, and SIM device 210e components such as field devices and processing equipment. System 200 also includes an operator console 212, instrument management system 235 and a mapping block 145.

Operator console 212 functions as a HMI for plant operators to monitor process and monitor alarms and take corrective actions (e.g. changing a set point). Instrument management system 235 functions as a HMI for plant maintenance personnel to monitor instrument health, and carry out calibration steps. Mapping block 245 includes mapping software 245a for interfacing the trainee and/or trainer console to the data model including converting actions in the at least partially virtual reality view to the data model of the simulated control and safety system and vice versa.

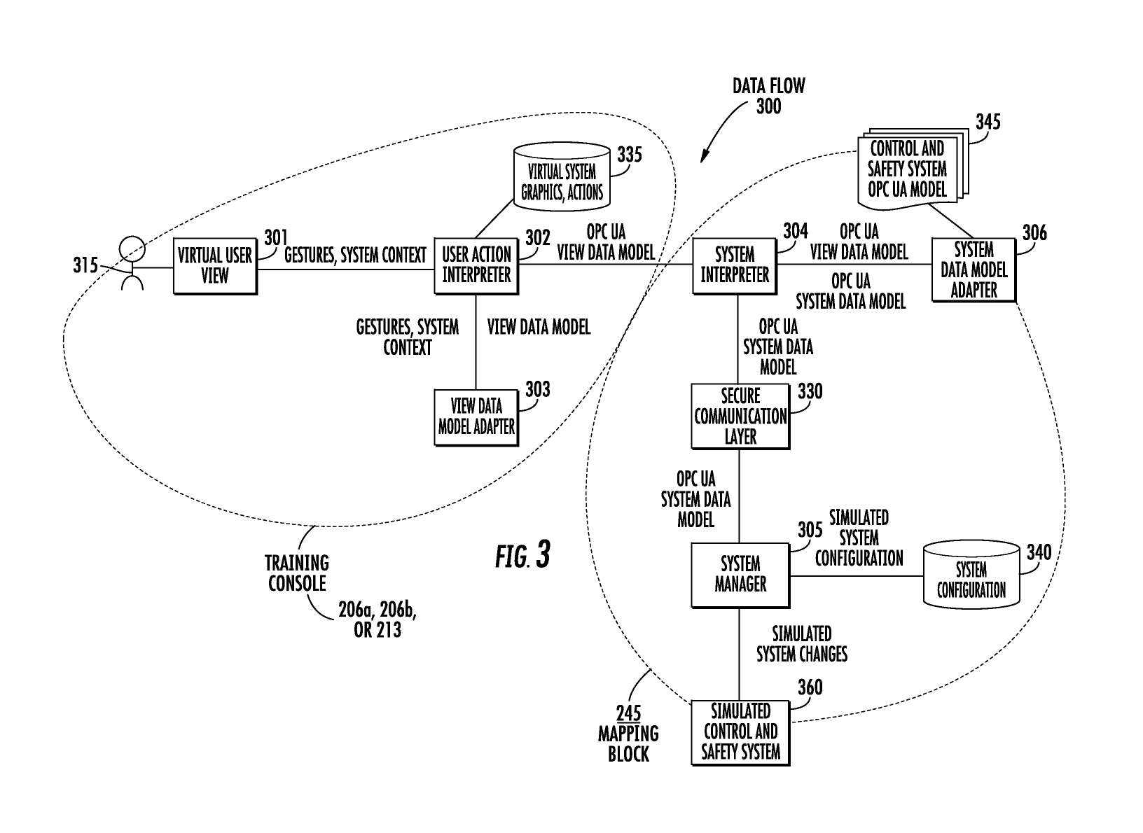

FIG. 3 shows a data flow 300 for an example method of simulated control and safety system maintenance training shown for an example OPC-based system. As disclosed above, the simulated control and safety system can be hosted in a private or in a public cloud (or other hosting) infrastructure.

The left side of data flow 300 is shown implemented for a trainee or trainer 315, by a stand-alone trainee console 206a or HMD-based trainee console 206b for the trainee, and/or a trainer console 213 for the trainer which provides the virtual user view 301 shown. The trainee console can comprise a mobile-based computing device. The user action interpreter 302 has access and runs stored virtual system graphics, and actions shown as 335 that ‘sees’ action (e.g., gestures) from the trainee (or optionally from the trainer). A trainee's actions such as gestures are captured from the virtual system view (generally from a camera at the trainee console). These actions are associated with a hardware device in the simulated control and safety system such as a cabinet, process controller, IO, wire, power or chassis.

Based on the actions of the trainee 315 the user action interpreter 302 is shown converting the action (e.g., a gesture) into an OPC UA-data model input. OPC UA is commonly used industrial machine-to-machine (M2M) communication protocol for interoperability developed by the OPC Foundation. 303 is a view data model adapter that helps recognize the actions such as gestures and system context in which an action is carried out. Block 304 implemented by the mapping block 245 is a system interpreter responsible for converting information received from user action interpreter 302 to the system manager 305 which understands it and vice versa.

System manager 305 implemented by the mapping block 245 is for understanding messages from the system interpreter 304 and communicating correctly with simulated control and safety system 360. 306 is a system data model adapter implemented by the mapping block 245 which has an OPC UA standard based representation (block 345 implemented by the mapping block 245) of simulated control and safety system data both configuration and rum time. 330 is a secure communication layer, 340 is a system configuration memory block, both implemented by the mapping block 245. 360 is a simulated control and safety system data representation corresponding to the modeled simulated control and safety system 210 shown in FIG. 2.

Believed to be unique disclosed features include:
1) Virtual immersive (or an AR) view and interaction of a control and safety system and its components using AR or VR technologies.
2) A system to simulate, configure and inject failures, some of which may not even be possible or difficult to produce with a conventional physical hardware control and safety system training setup. For example excessive Foundation Fieldbus (FF) H1 link communications errors, and controller memory corruption.
3) A standardized communication protocol between the AR or VR reality hardware(s) with simulated control and safety systems and internals, which will support a broader set of AR or VR systems.
4) Communication of the simulated control and safety training system with the actual running control and safety systems and networks for re-creating the behaviors of a running plant in the training system to provide real-time experiences to trainees. It is noted disclosed embodiments can also be extended in the future for related use cases including plant configuration training, process operations and control.

### EXAMPLES

Disclosed embodiments are further illustrated by the following specific Examples, which should not be construed as limiting the scope or content of this Disclosure in any way.

To use AR or VR technologies to act as a human machine interface (HMI) layer, there can be included a repository of graphic display algorithms for displaying to the user in 2D or 3D displays. The graphics can include representations (or visualizations) for the control and safety system hardware components including controllers, I/Os, (field devices, cabinet (e.g., an internal view of the cabinet on how the controller, and I/Os are mounted and commissioned), cables, and power sources.

The graphics will generally be unique to each type of hardware depending on vendor and form factor. For example, generation 1 controller graphics can be different from generation 2 controller graphics. Similarly, each device such as a transmitter may vary in in look and feel depending on the vendor. It should be noted that operations performed on each simulated hardware device will vary depending on the type of device and the version. So along with graphics the set of operations possible on each device type as supported by vendor is provided as well as a repository provided which can maintain this mapping. Accordingly an image of the controller and set of operation on it can be mapped. Similar mapping can be performed for other visual objects such as an I/O, switch or a power button.

Depending on whether AR or VR technology is used (e.g., Microsoft HOLOLENS or Oculus RIFT) and based on the technology vendor, the set of interactions that can be performed will vary. For example, voice interaction may not be supported by a particular AR or VR vendor. This means there is a mapping of the type of interactions supported by technology with set of actions possible on a particular type of device.

The control and safety system world deals with a controller and the set of parameters it monitors and controls. In the at least partially virtual reality view the visualization is more towards a real world representation. Apart from configuration information from the DCS the trainee console may need information such as building diagrams, electric cabling details, physical positioning of equipment and its physical view (3D). Some of this information may be provided in available standards such as a building Information model (or BIM), MIMOSA or CMMS systems. So the mapping of control and safety system configuration information to an additional physical view of the at least partially virtual reality view (e.g., mapping of controller physical location such building, floor number, to a simulated control and safety system device TAG) is included.

Once the configuration and mapping of data model is completed the next step is to map the interactions in console to operations of the control and safety system. The simulator should expose the set of trigger points or parameters which when activated creates the same effect of physical world changes. For example, if a cable is cut between an I/O and a device or power source disconnection, the setting of a related exposed simulated system parameter can trigger the same effect in the simulator world, such as an open wire alarm on the operator console.

Not all actions needs to be interfaced to the control and safety system. For example, a zoom in/zoom out in a particular area or equipment of the simulated system. The actions which are of interest to control and safety system are captured and interfaced through a protocol (command and response type) which can uniquely identify physical action of the trainee or trainer, to operation within the control and safety system. This arrangement makes it simple to handle the trainer fault injection scenario to create a failure scenario and evaluate whether a trainee is capable of handling the failure scenario as per a laid out procedure. Further to simplify the implementation, one can assume that control and safety system or simulator exposes an interface (e.g., OPC UA interface), however disclosed methods can generally be customized to any software interface. An OPC UA based data model can expose the data model of DCS/simulator and as well as act as communication layer to receive any command and share the real time information to the at least partially virtual reality-based view.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

1. A method of maintenance training simulation, comprising:
providing an at least partially virtual reality trainee console having training failure scenario and visualization software, a simulated control and safety system of an industrial plant represented as a data model of simulated hardware devices including at least one process controller, and a mapping block that implements mapping software for interfacing said trainee console to said data model;
said mapping block converting an injected hardware fault involving at least one of said simulated hardware devices to make a change to said data model which changes a current operating state of said simulated control and safety system;
displaying a response of said process controller to said changes to said current operating state in a first at least partially virtual reality-based view in said trainee console to said trainee;
said mapping block converting an action of said trainee responsive to said changes to said current operating state to generate a further change in said data model which further changes said current operating state of said simulated control and safety system, and
displaying a response of said process controller to said further changes in said current operating state in a second at least partially virtual reality-based view in said trainee console to at least said trainee.

2. The method of claim 1, wherein said trainee console comprises a head-mounted display (HMD).

3. The method of claim 1, further comprising an at least partially virtual reality trainer console having said training failure scenario and visualization software, wherein said trainer console provides said injected hardware fault.

4. The method of claim 1, wherein said data model comprises an Open Platform Communications unified architecture (OPC UA) model.

5. The method of claim 1, wherein said trainee console comprises a mobile computing device.

6. The method of claim 1, wherein said simulated hardware devices comprise input/output modules and field instruments.

7. The method of claim 1, wherein said simulated control and safety system is generated by modifying a commercially available process simulator including exposing internally maintained hardware fault flags.

8. A maintenance training simulation (MTS) system, comprising:
an at least partially virtual reality trainee console having training failure scenario and visualization software, said trainee console configured to act as a human machine interface (HMI) layer;
a simulated control and safety system of an industrial plant system represented as a data model of simulated hardware devices including at least one process controller,
and a mapping block that implements mapping software for interfacing said trainee console to said data model;
a network for communicably coupling together components in said MTS system including said trainee console and said simulated control and safety system;
said mapping block implementing mapping software for converting an injected hardware fault involving at least one of said simulated hardware devices to make a change to said data model which changes a current operating state of said simulated control and safety system;
said trainee console displaying a response of said process controller to said changes to said current operating state in a first at least partially virtual reality-based view to said trainee;
said mapping block for converting an action of said trainee responsive to said changes to said current operating state to generate a further change in said data model which further changes said current operating state of said simulated control and safety system, and
said trainee console displaying a response of said process controller to said further changes in said current operating state in a second at least partially virtual reality-based view to at least said trainee.

9. The MTS system of claim 8, wherein said trainee console comprises a head-mounted display (HMD).

10. The MTS system of claim 8, further comprising an at least partially virtual reality trainer console having said training failure scenario and visualization software, wherein said trainer console is configured for providing said injected hardware fault.

11. The MTS system of claim 8, wherein said data model comprises an Open Platform Communications unified architecture (OPC UA) model.

12. The MTS system of claim 8, wherein said trainee console comprises a mobile computing device.

13. The MTS system of claim 8, wherein said simulated hardware devices comprise input/output modules and field instruments.
